(19) United States
(12) Patent Application Publication
(10) Pub. No.: US 2012/0026535 A1
(43) Pub. Date: Feb. 2, 2012

(54) CONTROLLING AN IMAGING DEVICE WITH A WIRELESS COMMUNICATION DEVICE

(75) Inventors: Alan Neil Rovner, Vancouver, WA (US); Dane Nelson Wenzel, Gladstone, OR (US); Deborah Lynn Pritchett, Vancouver, WA (US)

(73) Assignee: Sharp Laboratories of America, Inc., Camas, WA (US)

(21) Appl. No.: 12/844,247

(22) Filed: Jul. 27, 2010

(51) Int. Cl. G06F 3/12; G06F 15/16

(52) U.S. Cl. 358/1.15; 709/230

(57) ABSTRACT

A method for scanning and printing using an imaging device with a wireless communication device is disclosed. A web method call that directs the imaging device to scan a document is transmitted based on user input. The entire scanned document is received and stored from the imaging device. The scanned document retains original formatting from the imaging device and is not stored on a third party server. A document that is entirely stored on the wireless communication device is directly transmitted to the imaging device. The document is not stored on a third party server and is in a format natively supported by the imaging device. A web method call that directs the imaging device to print the document is transmitted based on user input.

### TECHNICAL FIELD

The present disclosure relates generally to electronic systems. More specifically, the present disclosure relates to controlling an imaging device with a wireless communication device.

### BACKGROUND

The use of electronic devices has become commonplace in modern society. Many people use electronic devices as part of their work routine and for personal use at home. Electronic devices that are commonly used include wireless communication devices, such as personal computers, laptops or smart phones. Imaging devices are also commonly used.

Networks that allow several electronic devices to communicate with each other are also commonly used. For example, many computers and/or servers may be connected to a network, allowing the computers and/or servers to communicate with each other. Other electronic devices such as multifunction peripherals may also be directly or indirectly connected to a network.

As the capabilities of wireless devices increases, users require their devices to work with other devices. One such area may be imaging devices. However, since there are many different makers of wireless devices, this compatibility may present a challenge. Therefore, systems and methods for controlling an imaging device with a wireless communication device may be beneficial.

### BRIEF DESCRIPTION OF THE DRAWINGS

FIG. 1 is a block diagram illustrating a system for controlling an imaging device with a wireless communication device;

FIG. 2 is another block diagram illustrating a system for controlling an imaging device with a wireless communication device;

FIG. 3 is a sequencing diagram illustrating the signaling between an imaging application in a wireless communication device and an imaging device during a web method configuration;

FIG. 4 is a flow diagram illustrating a method for initializing and starting a scanning process in a web method configuration;

FIG. 5 is a flow diagram illustrating a method for completion of a scanning process in a web method configuration;

FIG. 6 is a flow diagram illustrating a method for initializing and starting a printing process in a web method configuration;

FIG. 7 is a flow diagram illustrating a method for completion of a printing process in a web method configuration; and

FIG. 8 is a block diagram illustrating hardware components that may be used in accordance with the systems and methods disclosed herein.

### DETAILED DESCRIPTION

A wireless communication device configured to scan at an imaging device is disclosed. The apparatus includes a processor and memory in electronic communication with the processor. Executable instructions are stored in the memory. The instructions are executable to transmit a web method call that directs the imaging device to scan a document based on user input. The instructions are also executable to receive and store the entire scanned document directly from the imaging device. The scanned document retains original formatting from the imaging device and is not stored on a third party server.

In one configuration, the transmitting and receiving may use an Institute of Electrical and Electronics Engineers (IEEE) 802.11 protocol or a cellular network. Furthermore, the wireless communication device may communicate with a web service on the imaging device using Simple Object Access Protocol (SOAP) via Hypertext Transfer Protocol (HTTP) messaging.

The web method call may invoke a web method that is part of an imaging platform running on the imaging device. The imaging platform may be Sharp's Open System Architecture (OSA) platform. The wireless communication device may receive the entire scanned document using a Hypertext Transfer Protocol (HTTP) listener thread.

The instructions stored in the memory may also be executable to initialize a web service object for a web service in the imaging device. The instructions may also be executable to send a web method call to get capabilities of the imaging device. The instructions may also be executable to populate a scan options menu based on the capabilities. The instructions may also be executable to send a web method call to subscribe to cancelation events and completion events in the imaging device. The instructions may also be executable to receive user input about selected scan options. The instructions may also be executable to send a web method call to set job settings with selected scan options.

A method for scanning at an imaging device with a wireless communication device is also disclosed. A web method call that directs the imaging device to scan a document is transmitted based on user input. The entire scanned document is received directly from the imaging device and stored. The scanned document retains original formatting from the imaging device and is not stored on a third party server.

A non-transitory tangible computer-readable medium for scanning at an imaging device with a wireless communication device is also disclosed. The computer-readable medium includes instructions thereon. The instructions are executable for transmitting a web method call that directs the imaging device to scan a document based on user input. The instructions are also executable for receiving and storing the entire scanned document directly from the imaging device. The scanned document retains original formatting from the imaging device and is not stored on a third party server.

A wireless communication device configured to print to an imaging device is disclosed. The apparatus includes a processor and memory in electronic communication with the processor. Executable instructions are stored in the memory. The instructions are executable to transmit a document that is entirely stored on the wireless communication device directly to the imaging device. The document is not stored on a third party server and is in a format natively supported by the imaging device. The instructions are also executable to transmit a web method call that directs the imaging device to print the document based on user input.

A method for printing to an imaging device with a wireless communication device is also disclosed. A document that is entirely stored on the wireless communication device is transmitted directly to the imaging device. The document is not stored on a third party server and is in a format natively supported by the imaging device. A web method call that directs the imaging device to print the document is transmitted based on user input.

A non-transitory tangible computer-readable medium for printing to an imaging device with a wireless communication device is also disclosed. The computer-readable medium includes instructions thereon. The instructions are executable for transmitting a document that is entirely stored on the wireless communication device directly to the imaging device. The document is not stored on a third party server and is in a format natively supported by the imaging device. The instructions are also executable for transmitting a web method call that directs the imaging device to print the document based on user input.

Advances in wireless technologies have increased demand and reduced the cost of wireless communication devices. The term “wireless communication device” refers to any device that wirelessly communicates for the purposes of computing, telecommunicating, reproducing, and presenting encoded information in myriad forms and applications. A wireless communication device may be a cellular phone, a smart phone, a personal digital assistant (PDA), a laptop computer, a netbook, an e-reader, a wireless modem, etc. A wireless communication device may alternatively be referred to as an access terminal, a mobile terminal, a mobile station, a remote station, a user terminal, a terminal, a subscriber unit, a subscriber station, a mobile device, a wireless device, user equipment (UE) or some other similar terminology.

These devices may include advanced capabilities, such as Wi-Fi networking, built-in web browser, built-in email client, and the ability to view photos and documents. Compatibility issues may accompany these advanced capabilities, i.e., wireless communications devices may not interface well with other devices. For example, it may be desirable to interface multi-function printers (MFPs) with wireless communication devices. For example, a wireless communication device may receive scanned documents directly from an imaging device or send print jobs directly to an imaging device. However, many vendors of wireless communication devices utilize various operating systems.

Therefore, the present systems and methods may enable a wireless communication device to control an imaging device, i.e., enable a wireless communication device to communicate with an imaging device for the purpose of imaging, e.g., scanning or printing. One possible strategy for imaging from a wireless communication device may interface with an imaging platform already running on an imaging device, e.g., Sharp Open Systems Architecture (OSA). Specifically, web methods may allow any wireless communication device that utilizes web services to scan or print to an imaging device using the imaging platform.

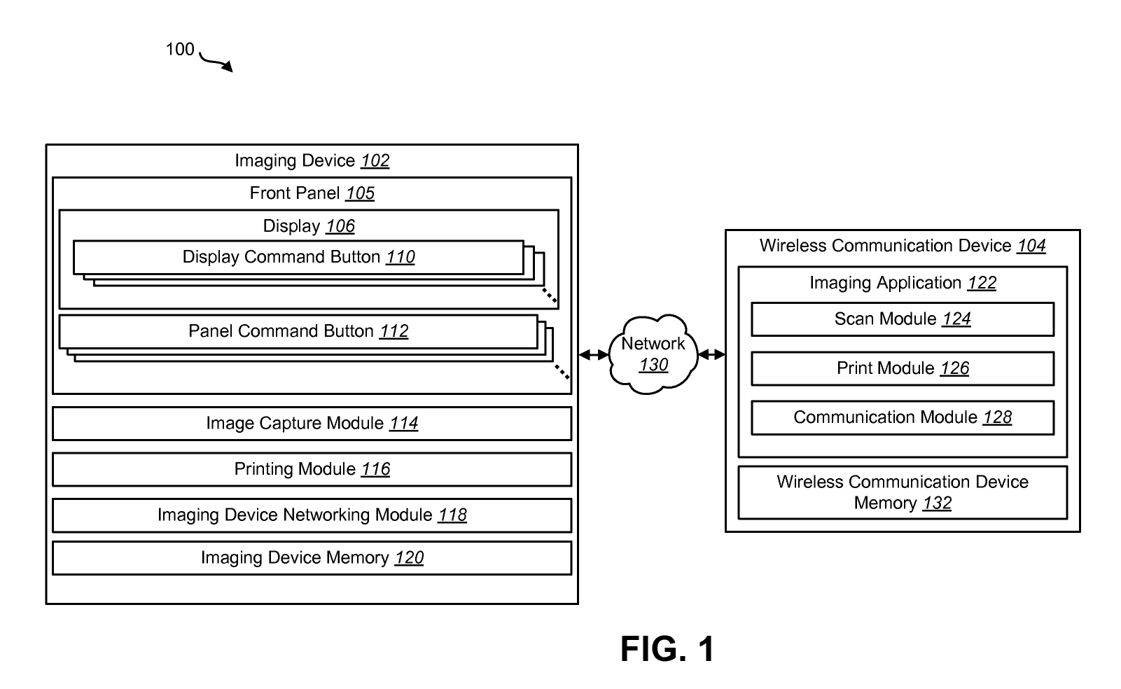

FIG. 1 is a block diagram illustrating a system 100 for controlling an imaging device 102 with a wireless communication device 104. The imaging device 102 and a wireless communication device 104 may be connected to and communicate with each other using a network 130. The imaging device 102 may include a front panel 105, an image capture module 114, a printing module 116, an imaging device networking module 118 and imaging device memory 120.

The term “imaging,” as used herein, should be interpreted broadly to include any process for producing a copy of a document onto paper, a computer screen, an electronic image or the like. Examples of imaging devices 102 include printers, facsimile devices, copiers, scanners, display monitors, multi-function peripherals (MFPs), imagesetters, platesetters, filing devices, web publishing devices and so forth. Documents that are sent to the imaging device 102 for printing are sometimes referred to as print jobs.

The front panel 105 may be a module attached to or integrated into the imaging device 102. The front panel 105 may include a display 106. One or more panel command buttons 112 may also be included on the front panel 105. The display 106 may display one or more thumbnail images and/or one or more display command buttons 110. Furthermore, the display 106 may display web pages or other useful information to a user. The display 106 may use any suitable display technology (e.g., Liquid Crystal Display (LCD), Organic Light Emitting Diode (OLED), Cathode Ray Tube (CRT), etc.). The display 106 may optionally be a touch panel. In this way, the display command button or buttons 110 may receive input from a user.

The image capture module 114 may be a hardware and/or software module that may be used to capture images. For example, the image capture module 114 may include a scanner, digital camera, or other module used to capture images. The imaging device networking module 118 may be a hardware and/or software module that may be used to format data for transmission over the network 130.

The imaging device memory 120 may comprise one or more devices used to store data. For example, the imaging device memory 120 may comprise Random Access Memory (RAM), Read Only Memory (ROM), Electrically Erasable Programmable Read Only Memory (EEPROM), some other type of memory or a combination of different types of memory. The imaging device memory 120 may be implemented as a magnetic disk, integrated circuit or semiconductor chip, some other electronic device for storing electronic data or a combination thereof.

The wireless communication device 104 may include an imaging application 122 and wireless communication device memory 132. The imaging application 122 may include a scan module 124, a print module 126 and a communication module 128. The scan module 124 may manually control the image capture module 114 in the imaging device 102 to scan documents and send them to the wireless communication device 104, i.e., with original formatting. The print module 126 may manually control the printing module 116 in the imaging device 102 to receive print jobs from the wireless communication device 104 and print them. The communication module 128 may format data for transmission across the network 130.

The imaging application 122 may send print jobs to and receive scanned documents from the imaging device 102. In other words, the wireless communication device 104 may communicate directly with the imaging device 102 (e.g., using the network 130) without a third party server. The wireless communication device memory 132 may be implemented as one or more types of electronic data storage. The wireless communication device memory 132 may store full image data (e.g., one or more full image files). Full image data may refer to image data that is obtained at a desired resolution and/or with full dimensions, for example.

The image capture module 114 may be used to obtain an electronic image. In one configuration, the image capture module 114 includes a scanner that may be used to scan a document. The image obtained by the image capture module may be stored in the imaging device memory 120 as full image data. The printing module 116 may process print jobs from either the imaging device memory 120 or the wireless communication device 104, i.e., at the direction of the print module 126 in the wireless communication device 104.

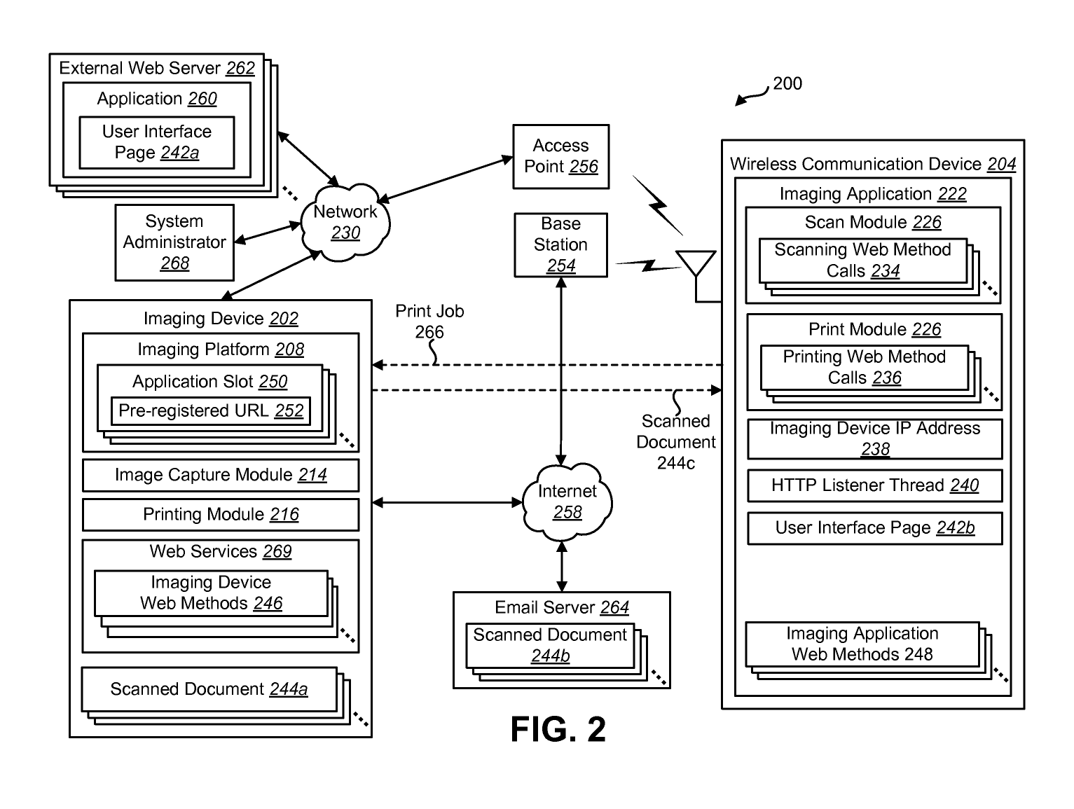

FIG. 2 is another block diagram illustrating a system 200 for controlling an imaging device 202 with a wireless communication device 204. The system 200 may include a wireless communication device 204 that uses an imaging application 222 to control the imaging device 202. The wireless communication device 204 may communicate with the imaging device 202 using an access point 256 connected via a local network 230 (e.g., Wi-Fi) or using a base station 254 connected via an outside network (e.g., the Internet 258). The term Wi-Fi refers to communication over a wireless local area network using any of the IEEE 802.11 protocols. As before, the image capture module 214 and printing module 216 may interface with a user or the wireless communication device 204 to scan or print documents, respectively.

In one configuration, the wireless communication device 204 may use a priority list to connect to a network. For example, the wireless communication device 204 may first attempt to connect with the access point 256, i.e., Wi-Fi. The access point 256 is likely to be more reliable than communication with the base station 254 since the access point 256 may be physically closer than the base station. Furthermore, the access point 256 may also be inside the corporate firewall, thus it may be faster. After a connection with the access point 256 is attempted, the wireless communication device 204 may attempt a communication with the base station 254 using 4G communication and lastly 3G communication. Even the slower Edge network would be permissible, but the time to transfer scan or print data may be affected.

The imaging device 202 may use an imaging platform 208 to integrate separate functions together in the imaging device, i.e., internet browsing, email client, interfacing with client devices, managing print jobs within the imaging device 202, etc. One possible imaging platform 208 is Sharp Open Systems Architecture (OSA) technology. For example, the imaging platform 208 may allow metadata to be added to scan jobs before emailing, access records from a database, display digital data, interface with other networked systems, control access to different imaging device 202 features, report activity to a billing system, communicate using web services, create custom menus, etc.

One possible way to transfer scanned documents 244a to the wireless communication device 204 may rely on email transactions via outside networks to transfer the scanned document 244a. In other words, the scanned document 244b may be transferred to an external email server 264 from the imaging device 202. From there, a user may access their account to view the scanned document 244b in their email client application. However, this relies on potentially insecure email transactions to deliver scanned documents 244b.

One possible way to print from a wireless communication device 204 may be to use a print driver supplied by the manufacturer of the imaging device 202. This is similar to how PC printing takes place. However, this may require the user to install a separate print driver. Furthermore, printing operations may be spread across the wireless communication device 204 and the imaging device 202, thus requiring updates to multiple devices.

In this non-web method configuration, the imaging platform 208 in the imaging device 202 may reserve eight platform application slots 250, e.g., Sharp OSA may reserve eight application slots 250. Each application slot 250 may be populated by the system administrator 268 via the imaging device's native web pages. To start a standard application 260, a user may select one of the eight applications from the imaging device 202 front panel. The imaging device 202 may initiate a socket connection to a pre-registered Universal Resource Locator (URL) 252 specified when the standard application 260 was registered. An external web server 262 may receive the request and serve a page written using legacy OSA user interface pages 242a, or standard HTML for newer imaging devices 202 that support the an embedded web browser. In this configuration, the standard application 260 may be started from the imaging device 202 front panel using pre-registered URLs 252. The standard application 260 may be included on an external web server 262. The network communications may occur over a wired network 230 within the corporate network topology and the user interface pages 242a may be displayed on the front panel of the imaging device 202. When printing in this configuration, the document to be printed may also reside on the external web server 262.

In contrast, the wireless communication device 204 of the present systems and methods may use an imaging application 222 to communicate with the imaging device 202 using web methods, i.e., using imaging device web methods 246 within the firmware of the imaging device 202 and imaging applications 248 in the wireless communication device 204. Therefore, web methods may be used to deliver scanned documents 244c (rather than email transfer) and to print documents (rather than using print drivers). The sequence of web methods called for scanning or printing may be similar to applications delivered in an imaging platform 208 software development kit (SDK), i.e., Sharp OSA SDK.

Furthermore, the present systems and methods may be advantageous because scanned documents 244d may be fully stored on the wireless communication device with original formatting, e.g., using an HTTP transaction. The imaging application 222 may implement an HTTP listener thread 240 to receive the incoming scanned document 244d. Additionally, the entire print job 266 may be transferred from the wireless communication device 204 to the imaging device 202 via an HTTP transaction over a wireless network connection.

In this web method configuration, no applications 260 may be registered on the imaging device 202. Instead, scanning web method calls 234 (from a scan module 224) and printing web method calls 236 (from a print module 226) may be made directly from the wireless communication device 204 to the imaging device 202. These web method calls 234, 236 may invoke imaging device web methods 246 that are part of the web services 269 in the imaging device 202. One possible advantage to this approach is that the eight application slots 250 may retain any existing registration values. Instead, of using an external web server 262, the imaging application 222 may be fully contained on the wireless communication device 204. Furthermore, the imaging application 222 may be started from the wireless communication device 204, not the imaging device 202. When on site, the wireless communication device 204 may communicate with an access point 256 (e.g., Wi-Fi). When off site, the wireless communication device 204 may communicate with a base station 254 (e.g., using a cellular 3G or 4G wireless network). Existing through-firewall technologies may be used to access the imaging device 202 inside a corporate environment. In one configuration, the wireless communication device 204 may use virtual private network (VPN) for secure access. Alternatively, a hole may be opened in the corporate firewall on a specific network port to allow mobile applications, such as the imaging application 222, to connect to the imaging device 202.

Additionally, the user interface pages 242b may be displayed on the wireless communication device 204 and both the user interface pages 242b and the document to be printed may reside entirely on the wireless communication device 204, i.e., the print job 266 is sent to the imaging device directly, without an external web server 262.

The web method configuration may use a web service endpoint value. In the non web method mode, there may not be an endpoint because there are no web methods. In this case, a legacy print driver or application 260 on an external web server 262 may be used. When the imaging device 202 is in external authority mode, the web service endpoint value may be included as part of the Hello( ) web method response. However, when controlling the imaging device from an imaging application 222 using web methods, the firmware of the imaging device 202 may be able to retrieve a web service endpoint value.

The imaging device 202 may also retrieve the user interface (UI) ID value for invoking the CreateJob( ) web method. In the non-web method configuration, the ID may be provided as part of the HTTP web page response. Furthermore, the imaging device 202 may use additional security measures to allow asynchronous connection from the wireless communication device 204.

The user of the wireless communication device 204 may configure the IP address 238 or Domain Name System (DNS) name of the imaging device 202 in the imaging application 222. Using the DNS name, the imaging application 222 may initiate a socket connection to the imaging device's web service 269, e.g., using a Wi-Fi, 3G or 4G network connection. The wireless communication device 204 may communicate with the web service 269 using Simple Object Access Protocol (SOAP) via HTTP messaging. This may use third party libraries or extensions to the operating system of the wireless communication device 204.

In one configuration, the imaging platform 208 may be Sharp's OSA platform that implements a core web service 269 called MFPCoreWS. This service may be resident in the imaging device 202 firmware. The web service 269 may expose 12 imaging device web methods 246 that are imaging device-implemented (imaging application 222 requests, imaging device 202 responds) and four imaging application web methods 248 that are imaging application-implemented (imaging device requests, imaging application responds). Not all available web methods may be used by the present systems and methods. The web methods 246, 248 may be invoked using SOAP methodology. The name and definition of each web method 246, 248 are defined below.

Imaging device web methods 246 may include one or more of:
CancelJob( ): Cancel a scan or print job that is currently in progress;
CloseJob( ): Close a scan or print job and free resources used by job;
CreateJob( ): Create a new scan or print job, retain identifier and resources for this job;
EnableDevice( ): Unlock MFP to allow access to MFP features;
ExecuteJob( ): Initiate a scan or print job previously defined by a CreateJob method call;
GetJobResults( ): Retrieve scan or print job results (how many pages used, any error state);
GetJobSettableElements( ): Retrieve the capabilities of this MFP for a scan or print job;
GetJobStatus( ): Retrieve running job status (started, error, finished, etc);
GetTotalCounters( ): Retrieve counts of pages scanned, printed, faxed and so forth;
SetJobElements( ): Set scan or print job metadata values (duplex, number of copies, etc);
ShowScreen( ): Cause MFP to display native or user-defined screen; and
Subscribe( ): Application requests to be notified of job-specific events (error, job complete).

Imaging application web methods 248 may include one or more of:
Authenticate( ): Verify user credentials to allow access to MFP features;
Authorize: Allow user to perform specific tasks (Copy, Scan, Print etc);
Event: MFP sends previously subscribed message to application; and
Hello: Boot up message sent from MFP to application defining MFP's features and capabilities.

Furthermore, in the configuration using Sharp OSA technology, only document formats natively supported by the imaging device 202 may be printed. This may includes Portable Document Format (PDF), XML Paper Specification (XPS), TXT, Joint Photographic Experts Group (JPEG), PostScript (PS), HDPhoto, Portable Network Graphic (PNG) and Tagged Image File Format (TIFF) documents, files or photos. There may be other solutions that may be used to translate non-supported file formats into native formats to universally allow printing from the wireless communication device 204, i.e., convert XLS file to PDF file for printing.

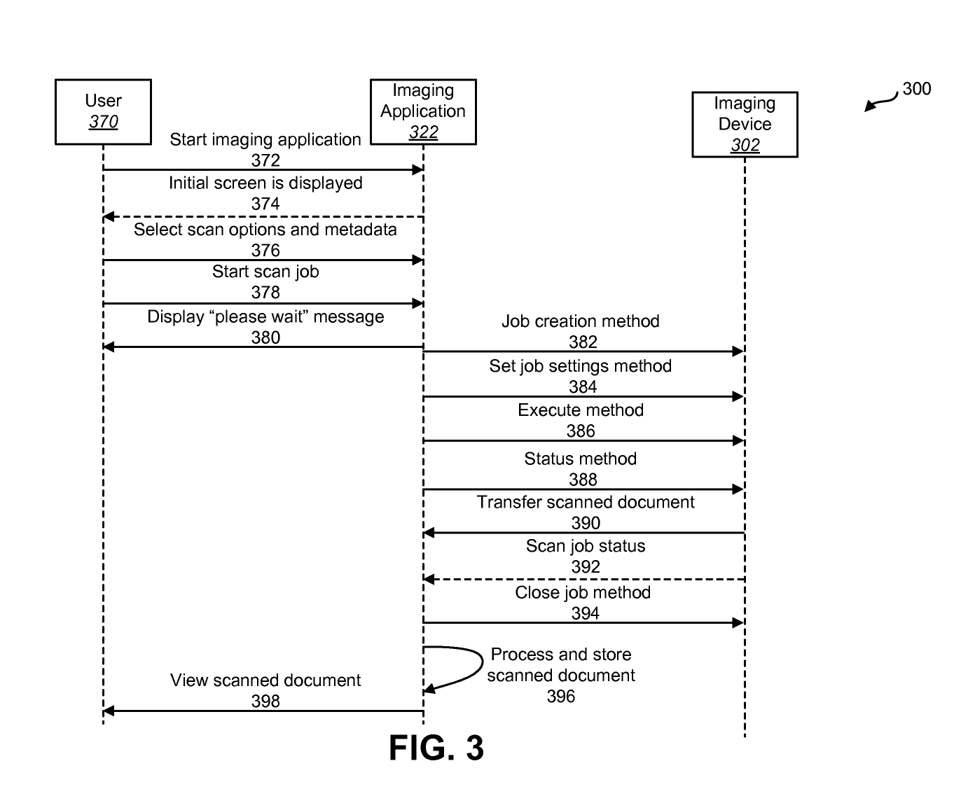

FIG. 3 is a sequencing diagram 300 illustrating the signaling between an imaging application 322 included in a wireless communication device 204 and an imaging device 302 during a web method configuration. Specifically, the sequencing diagram 300 illustrates the signaling when scanning using web methods. The scanning may include receiving input from and displaying information to a user 370 of a wireless communication device 204, e.g., the user 370 of a smart phone. The imaging application 322 may be started 372 (e.g., on a smart phone) and an initial screen may be displayed 374. The user 370 may select 376 scan options and metadata and start 378 the scan job (before starting 378 the scan job, the user 370 may place the source document into the auto feeder or on the platen). The imaging application 322 may display 380 a “please wait” message to the user 370.

After the user presses the “start scan” button 378, the imaging application 322 may initiate a series of method calls, which may cause the document to be scanned, e.g., web method calls. Specifically, the imaging application 322 may call a job creation method 382 that creates a new scan or print job, e.g., CreateJob( ) web method in Sharp OSA. The imaging application 322 may also call a set job settings method 384 to set scan or print job metadata values (duplex, number of copies, etc.), e.g., SetJobElements( ) web method in Sharp OSA. The imaging application 322 may also call an execute method 386 that initiates the scan or print job previously defined by the job creation method 382, e.g., CreateJob( ) web method in Sharp OSA. The imaging application 322 may also call a status method 388 that retrieves running job status (started, error, finished, etc.), e.g., GetJobStatus web method in Sharp OSA.

At this point in a non-web method configuration, the imaging device 302 may transfer the scanned document to an external web server using HTTP messaging. In the illustrated web method configuration, however, there is no equivalent, i.e., the wireless communication device 204 does not include a web server. Instead, the imaging device 302 may transfer 390 the scanned document to the imaging application 322, e.g., using HTTP. The imaging application 322 may implement an HTTP listener thread to receive the incoming scanned document. This listener thread may be implemented on a non-standard port in order to prevent any interference with the wireless communication device's native web browser application. The non-standard URL of the wireless communication device may be passed to the imaging device 302 as one of the metadata arguments when calling the set job settings method 384 along with other scanning-related metadata values.

Following transfer of the scanned document to the imaging application 322, the imaging device 302 may send the scan job status 392 to the imaging application 322. The imaging application 322 may also call a close job method 394 that frees resources used by the scan job, e.g., a CloseJob( ) web method in Sharp OSA. The imaging application 322 may process and store the scanned document 396. The scanned document may be entirely stored at the imaging application 322, i.e., not stored on an external email server. After processing and storage 396, the user 370 may view the scanned document 398.

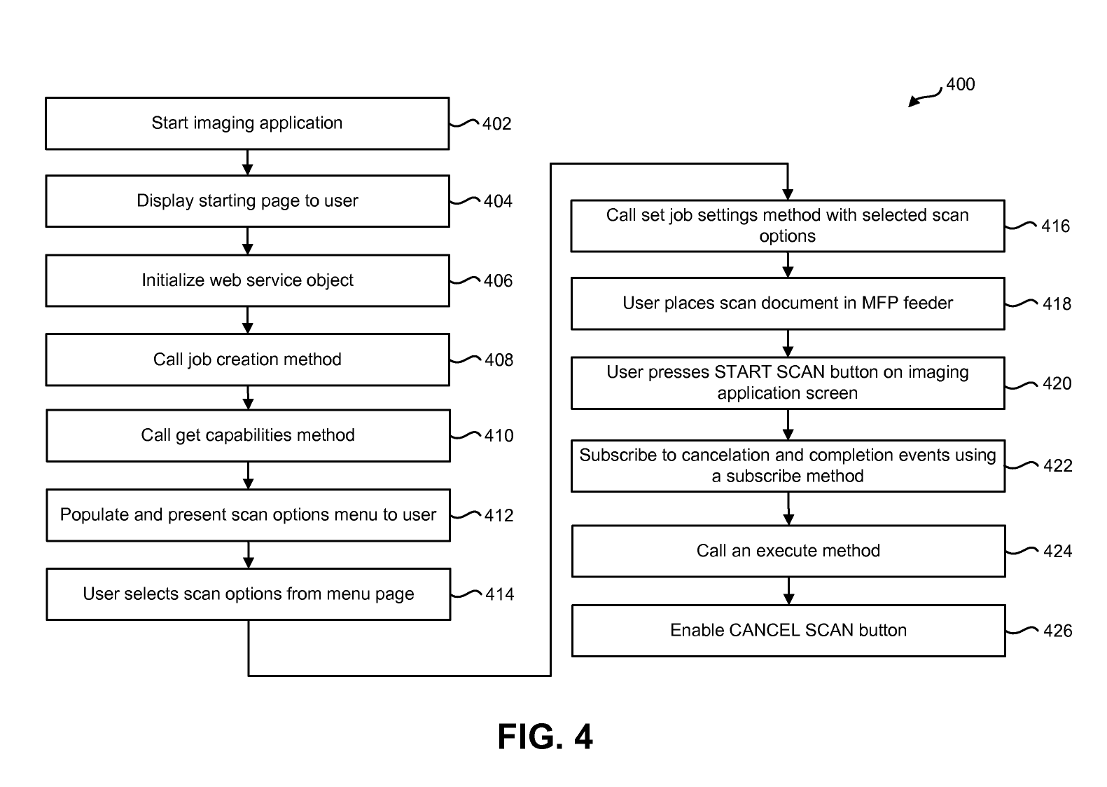

FIG. 4 is a flow diagram illustrating a method 400 for initializing and starting a scanning process in a web method configuration. The method 400 may be performed by an imaging application 222 in a wireless communication device 204 and a user. The imaging application 222 may be started 402, e.g., by the user of the wireless communication device 202. The imaging application 222 may also display 404 a starting page to the user. The imaging application 222 may also initialize 406 a web service object and call a job creation method 408, e.g., CreateJob( ) that retains an identifier and resources for this job. Security credentials may be used to complete a CreateJob( ) call. The imaging application 222 may also call a get capabilities method 410 to retrieve the capabilities of the imaging device, e.g., GetJobSettableElements( ) in Sharp OSA. The imaging application 222 may also populate 412 and present scan options menu to the user, i.e., create a user interface with the possible options retrieved from the get capabilities method 410. The scan options menu may use one or more text boxes, radio buttons, drop-down lists, list boxes, check boxes, datagrids, etc. The imaging application 222 may also receive user input about selected scan preferences, i.e., the user selects 414 scan options from a menu page.

The imaging application 222 may also call a set job settings method 416 using the selected scan preferences, e.g., SetJobElements( ) web method. The user may place 418 the scan document in the auto feeder or on the platen of the imaging device 202. The imaging application 222 may also receive user input to start the scan job, i.e., the user may press 420 a “start scan” button on the imaging application 222 screen. The imaging application 222 may also subscribe 422 to cancelation and completion events using a subscribe method, e.g., the imaging application 222 may subscribe to OnJobCancel and OnJobComplete events using Sharp OSA's Subscribe( ) web method. This may be a request to be notified about job-specific events (error, job complete, etc.). The imaging application 222 may also call 424 an execute method, e.g., ExecuteJob( ) web method. Once called, the scanning may actually begin. Therefore, in one configuration, the ExecuteJob( ) web method call may be transmitted in response to the user pressing the “start scan” button on the imaging application 222. The imaging application 222 may also enable 426 a “cancel scan” button, after which the scan job may be canceled.

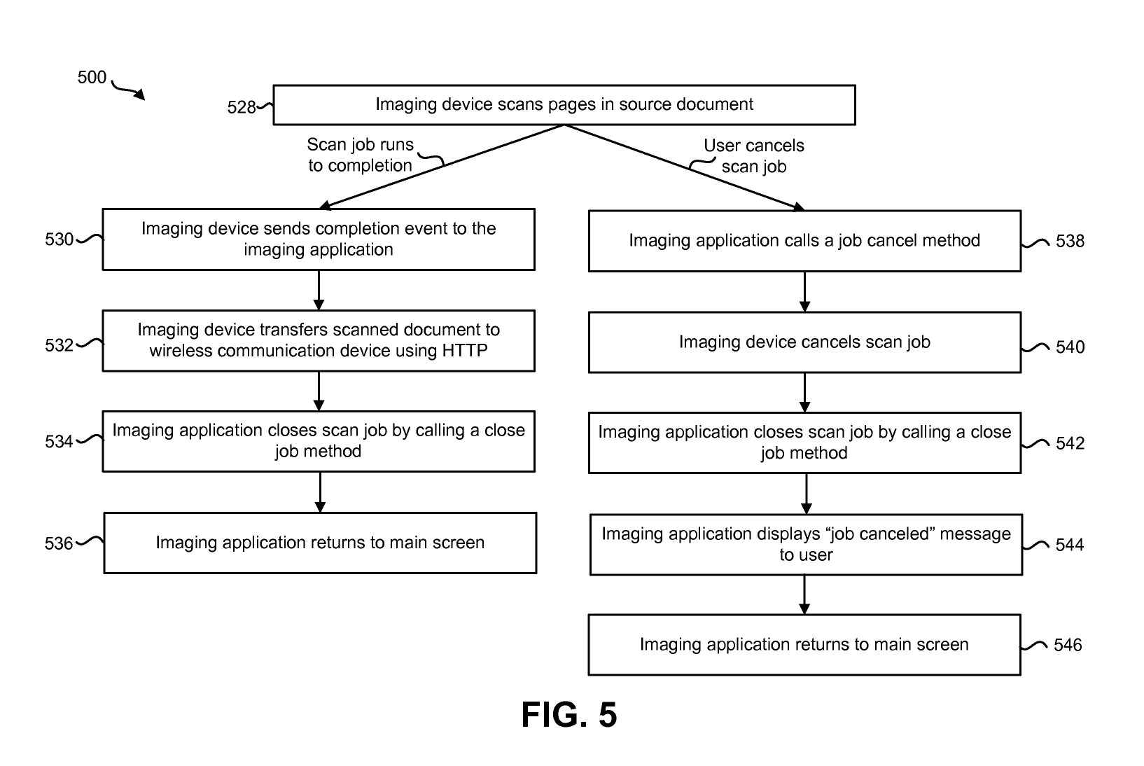

FIG. 5 is a flow diagram illustrating a method 500 for completion of a scanning process in a web method configuration. In other words, the method 500 may be performed once the imaging device 202 has started scanning the document. The method 500 may be performed by an imaging device 202 and an imaging application 222 in a wireless communication device 204. At the request of the imaging application 222, the imaging device 202 may scan 528 pages in the source document. This may occur independently of the wireless communication device 204 and its imaging application 222.

In one configuration, the scan job runs to completion. In this configuration, the imaging device 202 may send 530 a completion event to the imaging application 222, e.g., the imaging device 202 may invoke the Event( ) web method in the imaging application 222. This may be in response to the previous subscription 422 in FIG. 4. The imaging device 202 may transfer 532 the scanned document to the wireless communication device 204 using HTTP. The imaging application 222 may close the scan job by calling 534 a close job method that frees resources used by the job, e.g., CloseJob( ) web method. The imaging application 222 may also return 536 to a main screen. At this point, the user may view the document using a viewing application.

Alternatively, the scan job may be canceled. If canceled, the imaging application may call 538 a job cancel method to cancel the in-progress scan job, e.g., Sharp OSA's CancelJob( ) web method. In response, the imaging device 202 may cancel 540 the scan job. The imaging application 222 may close the scan job by calling 542 a close job method that frees resources used by the job, e.g., CloseJob( ) web method. The imaging application 222 may also display 544 a “job canceled” message to the user and return 546 to the main screen.

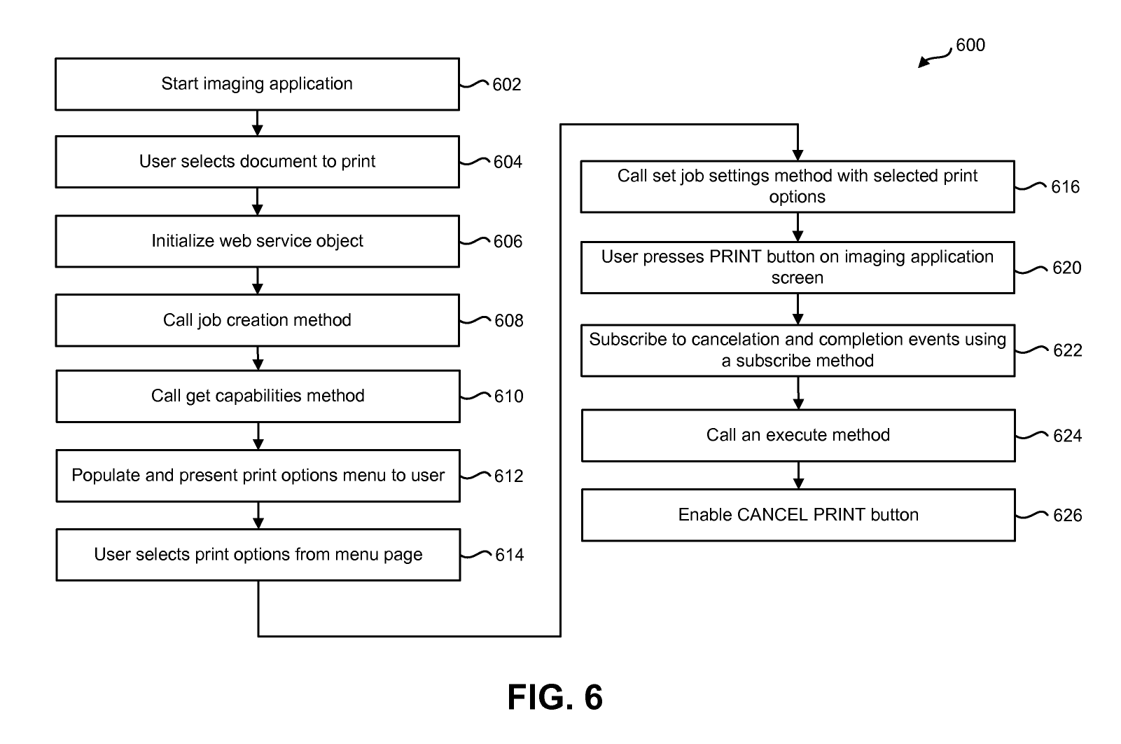

FIG. 6 is a flow diagram illustrating a method 600 for initializing and starting a printing process in a web method configuration. The method 600 may be performed by an imaging application 222 in a wireless communication device 204 and a user. The imaging application 222 may be started 602, e.g., by the user of the wireless communication device 202. The user may select 604 a document to print. The imaging application 222 may also initialize 606 a web service object and call a job creation method 608, e.g., CreateJob( ) that retains an identifier and resources for this job. The imaging application 222 may also call a get capabilities method 610 to retrieve the capabilities of the imaging device, e.g., GetJobSettableElements( ) in Sharp OSA. The imaging application 222 may also populate 612 and present print options menu to the user, i.e., create a user interface with the possible options retrieved from the get capabilities method 610. The print options menu may use one or more text boxes, radio buttons, drop-down lists, list boxes, check boxes, datagrids, etc. The imaging application 222 may also receive user input that selects 614 print preferences.

The imaging application 222 may also call a set job settings method 616 using the selected print preferences, e.g., SetJobElements( ) web method. The imaging application 222 may also receive user input to start the print job, i.e., the user may press 620 a “print” button on the imaging application 222 screen. The imaging application 222 may also subscribe 622 to cancelation and completion events using a subscribe method, e.g., the imaging application 222 may subscribe to OnJobCancel and OnJobComplete events using Sharp OSA's Subscribe( ) web method. This may be a request to be notified about job-specific events (error, job complete, etc.).

The imaging application 222 may also call 624 an execute method, e.g., ExecuteJob( ) web method. This may include transferring the print document to the imaging device 202 via callback URL. In one configuration, the imaging application 222 may use the same approach as a standard Sharp OSA application to transfer the document to be printed to the imaging device 202. Specifically, one of the arguments to the SetJobElements( ) web method includes a callback URL, which includes the filename and path of the document to be printed. The imaging application 222 may implement an HTTP listener thread that responds to the callback request. When requested by the imaging device 202, the imaging application 204 may use standard file I/O commands to open the print document and use an HTTP Response object to dump the file contents to the imaging device 202. The term “HTTP Response” is generic and refers to a response sent via HTTP messaging using one of many possible languages. Therefore, in one configuration, the ExecuteJob( ) web method may be transmitted in response to a user pressing the “print” button on the imaging application 222. The imaging application 222 may also enable 626 “cancel print” button, after which the print job may be canceled.

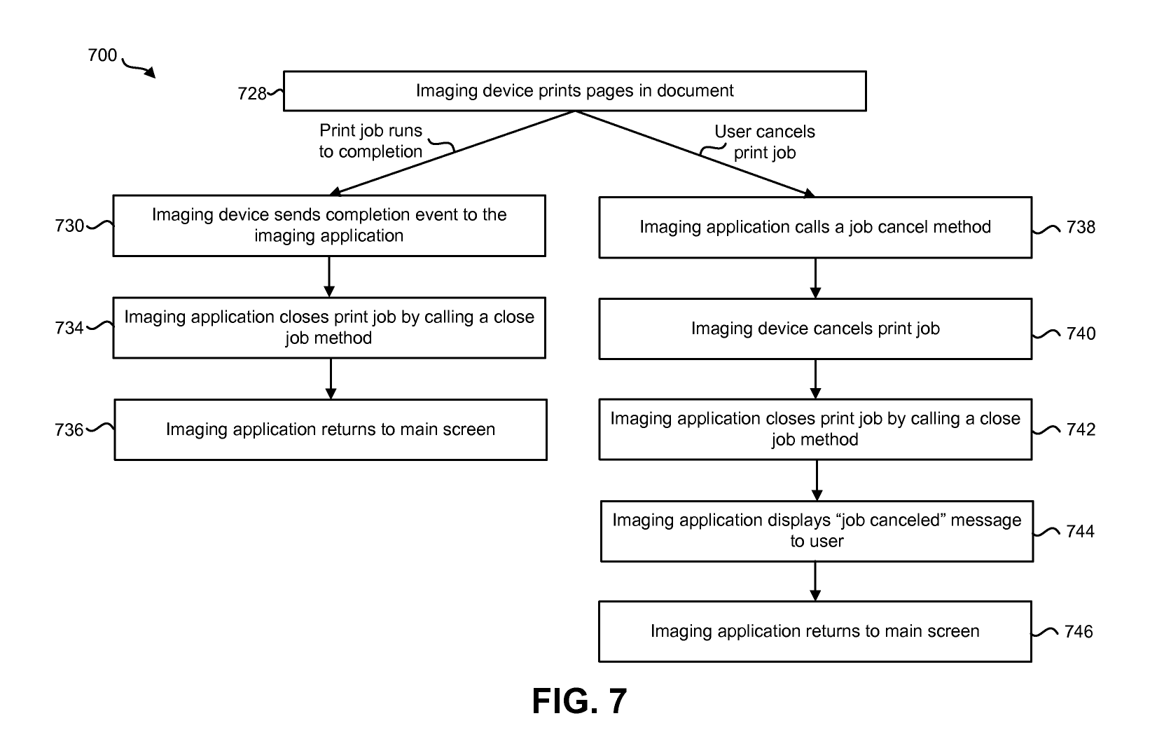

FIG. 7 is a flow diagram illustrating a method 700 for completion of a printing process in a web method configuration. In other words, the method 700 may be performed once the imaging device 202 has started printing the document. The method 700 may be performed by an imaging device 202 and an imaging application 222 in a wireless communication device 204. At the request of the imaging application 222, the imaging device 202 may print 728 pages in the document. This may occur independently of the wireless communication device 204 and its imaging application 222.

In one configuration, the print job runs to completion. In this configuration, the imaging device 202 may send 730 a completion event to the imaging application 222, e.g., the imaging device 202 may invoke the Event( ) web method in the imaging application 222. This may be in response to the previous subscription 622 in FIG. 6. The imaging application 222 may close the print job by calling 734 a close job method that frees resources used by the job, e.g., CloseJob( ) web method. The imaging application 222 may also return 736 to a main screen.

Alternatively, the print job may be canceled. If canceled, the imaging application may call 738 a job cancel method to cancel the in-progress print job, e.g., Sharp OSA's CancelJob( ) web method. In response, the imaging device 202 may cancel 740 the print job. The imaging application 222 may also close the print job by calling 742 a close job method that frees resources used by the job, e.g., CloseJob( ) web method. The imaging application 222 may also display 744 a “job canceled” message to the user. The imaging application 222 may also return 746 to the main screen.

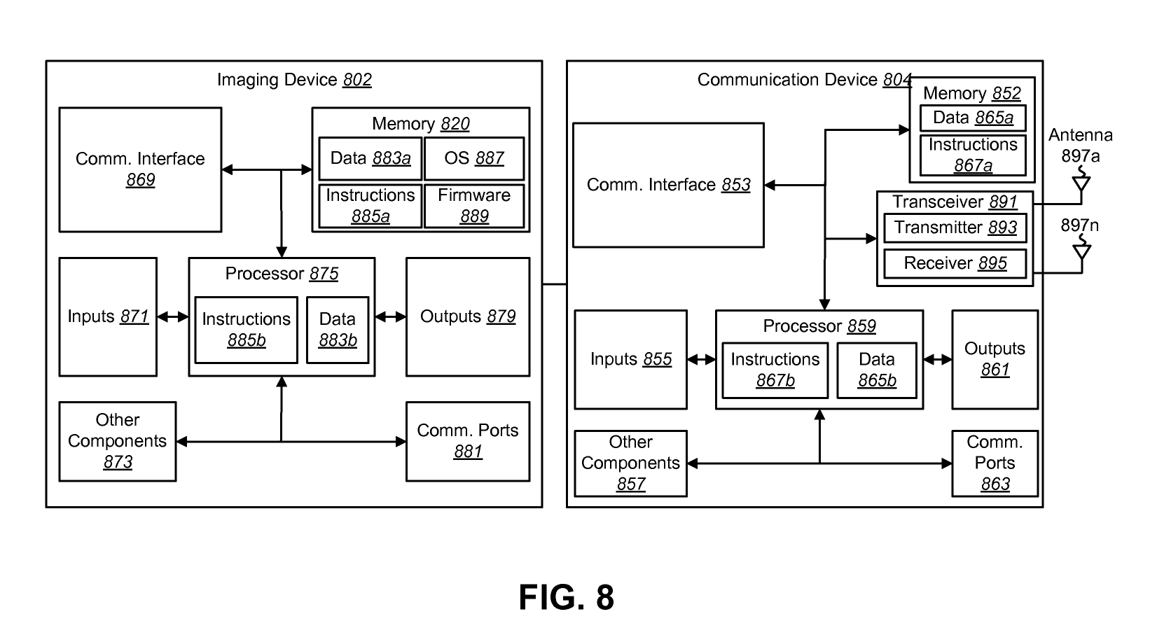

FIG. 8 is a block diagram illustrating hardware components that may be used in accordance with the systems and methods disclosed herein. The systems and methods disclosed may be implemented and used with a wireless communication device 804 and an imaging device 802 (e.g., MFP). The hardware components typically utilized in a wireless communication device 804 are illustrated in FIG. 8. A wireless communication device 804 may include a processor 859 (e.g., Central Processing Unit (CPU)) in electronic communication with input components or devices 855 and/or output components or devices 861. The processor 859 is operably connected to input 855 and/or output devices 861 capable of electronic communication with the processor 859, or, in other words, to devices capable of input and/or output in the form of an electrical signal. Some configurations of wireless communication devices 804 may include the inputs 855, outputs 861 and the processor 859 within the same physical structure or in separate housings or structures.

The wireless communication device 804 may also include memory 852. Memory 852, which may include both read-only memory (ROM), random access memory (RAM) or any type of device that may store information, provides instructions 867a and data 865a to the processor 859. A portion of the memory 852 may also include non-volatile random access memory (NVRAM). The memory 852 may be a separate component from the processor 859, or it may be on-board memory 852 included in the same part as the processor 859. For example, microcontrollers often include a certain amount of on-board memory. Memory 852 may store data 865a and instructions 867a. The data 865a and/or instructions 867a may be used by the wireless communication device to perform the methods disclosed herein. That is, the processor 859 may use data 865a and or instructions 867a stored in memory 852 to perform the methods disclosed herein. Furthermore, data 865b and/or instructions 867b may also be loaded onto the processor 859.

The processor 859 is also in electronic communication with a communication interface 853. The communication interface 853 may be used for communications with other wireless communication devices 804, imaging devices 802, servers, etc. Thus, the communication interfaces 853 of the various wireless communication devices 804 may be designed to communicate with each other to send signals or messages between the wireless communication devices 804.

The wireless communication device 804 may also include other communication ports 863. In addition, other components 857 may also be included in the wireless communication device 804.

Many kinds of different devices may be used with configurations of the systems and methods disclosed herein. The wireless communication device 804 may be a one-chip computer, such as a microcontroller, a one-board type of computer, such as a controller, a typical desktop computer, a Personal Digital Assistant (PDA), a Unix-based workstation, etc. Accordingly, the block diagram of FIG. 8 is only meant to illustrate typical components of a wireless communication device 804 and is not meant to limit the scope of the systems and methods disclosed herein.

The wireless communication device 804 is in electronic communication with the imaging device 802 (e.g., MFP). An imaging device 802 is a device that receives or transmits an imaging job, such as a Multi-Function Peripheral (“MFP”) or wireless communication device. Imaging devices 802 include, but are not limited to, physical printers, multi-functional peripherals, a printer pool, a printer cluster, a fax machine, a plotter, a scanner, a copier, a logical device, a computer monitor, a file, an electronic whiteboard, a document server, etc. A typical printing device, such as a physical printer, fax machine, scanner, multi-functional peripheral or copier is a type of wireless communication device. As a result, an imaging device 802 also includes a processor 875, memory 820, communications interface 869, inputs 871, outputs 879, communication ports 881 and/or other components 873 as similarly described in relation to the wireless communication device 804. The imaging device 802 memory 820 may also include data 883a and instructions 885a. The data 883b and instructions 885b may be loaded onto the processor 875. The imaging device 802 memory 820 may also include an operating system 887 and firmware 889. Examples of an operating system that may be used on an imaging device 802 include VxWorks, Linux, or Embedded Windows XP, etc. The firmware 889 may comprise data and or instructions used for the proper operation of the imaging device 802. The imaging device 802 may be a single or a plural grouping (e.g., pool or cluster) of two or more devices. The wireless communication device 804 may also include a housing that includes a transmitter 893 and a receiver 895 (which may be combined into a transceiver 891) with one or more antennas 897a-n electrically coupled to the transceiver 891.

As used herein, the term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory may be integral to a processor and still be said to be in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A wireless communication device configured to scan at an imaging device, comprising:
a processor;
memory in electronic communication with the processor;
instructions stored in the memory, the instructions being executable to:
transmit a web method call that directs the imaging device to scan a document based on user input; and
receive and store the entire scanned document directly from the imaging device, wherein the scanned document retains original formatting from the imaging device and is not stored on a third party server.

2. The wireless communication device of claim 1, wherein the instructions executable to transmit and receive use an Institute of Electrical and Electronics Engineers (IEEE) 802.11 protocol or a cellular network.

3. The wireless communication device of claim 1, wherein the instructions to transmit the web method call comprise instructions executable to communicate with a web service on the imaging device using Simple Object Access Protocol (SOAP) via Hypertext Transfer Protocol (HTTP) messaging.

4. The wireless communication device of claim 1, wherein the web method call invokes a web method that is part of an imaging platform running on the imaging device.

5. The wireless communication device of claim 4, wherein the imaging platform is Sharp's Open System Architecture (OSA) platform.

6. The wireless communication device of claim 1, wherein the instructions executable to receive comprise instructions executable to receive the entire scanned document using a Hypertext Transfer Protocol (HTTP) listener thread.

7. The wireless communication device of claim 1, further comprising instructions executable to:
initialize a web service object for a web service in the imaging device;
send a web method call to get capabilities of the imaging device;
populate a scan options menu based on the capabilities;
send a web method call to subscribe to cancelation events and completion events in the imaging device;
receive user input about selected scan options; and
send a web method call to set job settings with selected scan options.

8. A method for scanning at an imaging device with a wireless communication device, comprising:
transmitting a web method call that directs the imaging device to scan a document based on user input; and
receiving and storing the entire scanned document directly from the imaging device, wherein the scanned document retains original formatting from the imaging device and is not stored on a third party server.

9. The method of claim 8, wherein the transmitting and receiving uses an Institute of Electrical and Electronics Engineers (IEEE) 802.11 protocol or a cellular network.

10. The method of claim 8, wherein the transmitting the web method call comprises communicating with a web service on the imaging device using Simple Object Access Protocol (SOAP) via Hypertext Transfer Protocol (HTTP) messaging.

11. The method of claim 8, wherein the web method call invokes a web method that is part of an imaging platform running on the imaging device.

12. The method of claim 11, wherein the imaging platform is Sharp's Open System Architecture (OSA) platform.

13. The method of claim 8, wherein the receiving comprises receiving the entire scanned document using a Hypertext Transfer Protocol (HTTP) listener thread.

14. The method of claim 8, further comprising:
initializing a web service object for a web service in the imaging device;
sending a web method call to get capabilities of the imaging device;
populating a scan options menu based on the capabilities;
sending a web method call to subscribe to cancelation events and completion events in the imaging device;
receiving user input about selected scan options; and
sending a web method call to set job settings with selected scan options.

15. A non-transitory tangible computer-readable medium for scanning at an imaging device with a wireless communication device, comprising executable instructions for:
transmitting a web method call that directs the imaging device to scan a document based on user input; and
receiving and storing the entire scanned document directly from the imaging device, wherein the scanned document retains original formatting from the imaging device and is not stored on a third party server.

16. The computer-readable medium of claim 15, wherein the executable instructions for transmitting and receiving comprise instructions for using an Institute of Electrical and Electronics Engineers (IEEE) 802.11 protocol or a cellular network.

17. The computer-readable medium of claim 15, wherein the executable instructions for transmitting the web method call comprises executable instructions for communicating with a web service on the imaging device using Simple Object Access Protocol (SOAP) via Hypertext Transfer Protocol (HTTP) messaging.

18. The computer-readable medium of claim 15, wherein the web method call invokes a web method that is part of an imaging platform running on the imaging device.

19. The computer-readable medium of claim 18, wherein the imaging platform is Sharp's Open System Architecture (OSA) platform.

20. The computer-readable medium of claim 15, wherein the executable instructions for receiving comprise instructions for receiving the entire scanned document using a Hypertext Transfer Protocol (HTTP) listener thread.

21. The computer-readable medium of claim 15, further comprising executable instructions for:
initializing a web service object for a web service in the imaging device;
sending a web method call to get capabilities of the imaging device;
populating a scan options menu based on the capabilities;
sending a web method call to subscribe to cancelation events and completion events in the imaging device;
receiving user input about selected scan options; and
sending a web method call to set job settings with selected scan options.

22. A wireless communication device configured to print to an imaging device, comprising:
a processor;
memory in electronic communication with the processor;
instructions stored in the memory, the instructions being executable to:
transmit a document that is entirely stored on the wireless communication device directly to the imaging device, wherein the document is not stored on a third party server and is in a format natively supported by the imaging device; and
transmit a web method call that directs the imaging device to print the document based on user input.

23. The wireless communication device of claim 22, wherein the instructions executable to transmit use an Institute of Electrical and Electronics Engineers (IEEE) 802.11 protocol or a cellular network.

24. The wireless communication device of claim 22, wherein the instructions to transmit the web method call comprise instructions executable to communicate with a web service on the imaging device using Simple Object Access Protocol (SOAP) via Hypertext Transfer Protocol (HTTP) messaging.

25. The wireless communication device of claim 22, wherein the web method call invokes a web method that is part of an imaging platform running on the imaging device.

26. The wireless communication device of claim 25, wherein the imaging platform is Sharp's Open System Architecture (OSA) platform.

27. The wireless communication device of claim 22, further comprising instructions executable to listen for communication from the imaging device using a Hypertext Transfer Protocol (HTTP) listener thread.

28. The wireless communication device of claim 22, further comprising instructions executable to:
initialize a web service object for a web service in the imaging device;
send a web method call to get capabilities of the imaging device;
populate a print options menu based on the capabilities;
send a web method call to subscribe to cancelation events and completion events in the imaging device;
receive user input about selected print options; and
send a web method call to set job settings with selected print options.

29. A method for printing to an imaging device with a wireless communication device, comprising:
transmitting a document that is entirely stored on the wireless communication device directly to the imaging device, wherein the document is not stored on a third party server and is in a format natively supported by the imaging device; and
transmitting a web method call that directs the imaging device to print the document based on user input.

30. The method of claim 29, wherein the transmitting uses an Institute of Electrical and Electronics Engineers (IEEE) 802.11 protocol or a cellular network.

31. The method of claim 29, wherein the transmitting the web method call comprises communicating with a web service on the imaging device using Simple Object Access Protocol (SOAP) via Hypertext Transfer Protocol (HTTP) messaging.

32. The method of claim 29, wherein the web method call invokes a web method that is part of an imaging platform running on the imaging device.

33. The method of claim 32, wherein the imaging platform is Sharp's Open System Architecture (OSA) platform.

34. The method of claim 29, further comprising listening for communication from the imaging device using a Hypertext Transfer Protocol (HTTP) listener thread.

35. The method of claim 29, further comprising:
initializing a web service object for a web service in the imaging device;
sending a web method call to get capabilities of the imaging device;
populating a print options menu based on the capabilities;
sending a web method call to subscribe to cancelation events and completion events in the imaging device;
receiving user input about selected print options; and
sending a web method call to set job settings with selected print options.

36. A non-transitory tangible computer-readable medium for printing to an imaging device with a wireless communication device, comprising executable instructions for:
transmitting a document that is entirely stored on the wireless communication device directly to the imaging device, wherein the document is not stored on a third party server and is in a format natively supported by the imaging device; and
transmitting a web method call that directs the imaging device to print the document based on user input.

37. The computer-readable medium of claim 36, wherein the executable instructions for transmitting uses an Institute of Electrical and Electronics Engineers (IEEE) 802.11 protocol or a cellular network.

38. The computer-readable medium of claim 36, wherein the executable instructions for transmitting the web method call comprises executable instructions for communicating with a web service on the imaging device using Simple Object Access Protocol (SOAP) via Hypertext Transfer Protocol (HTTP) messaging.

39. The computer-readable medium of claim 36, wherein the web method call invokes a web method that is part of an imaging platform running on the imaging device.

40. The computer-readable medium of claim 39, wherein the imaging platform is Sharp's Open System Architecture (OSA) platform.

41. The computer-readable medium of claim 36, further comprising executable instructions for listening for communication from the imaging device using a Hypertext Transfer Protocol (HTTP) listener thread.

42. The computer-readable medium of claim 36, further comprising executable instructions for:
initializing a web service object for a web service in the imaging device;
sending a web method call to get capabilities of the imaging device;
populating a print options menu based on the capabilities;
sending a web method call to subscribe to cancelation events and completion events in the imaging device;
receiving user input about selected print options; and
sending a web method call to set job settings with selected print options.
